(19) United States
(12) Patent Application Publication
(10) Pub. No.: US 2015/0310287 A1
(43) Pub. Date: Oct. 29, 2015

(54) GAZE DETECTION AND WORKLOAD ESTIMATION FOR CUSTOMIZED CONTENT DISPLAY

(71) Applicant: Ford Global Technologies, LLC, Dearborn, MI (US)

(72) Inventors: Fling TSENG, Ann Arbor, MI (US); Hsin-hsiang YANG, Ann Arbor, MI (US); Kwaku O. PRAKAH-ASANTE, Commerce Township, MI (US); Walter Joseph TALAMONTI, Dearborn, MI (US)

(73) Assignee: Ford Global Technologies, LLC, Dearborn, MI (US)

(21) Appl. No.: 14/263,197

(22) Filed: Apr. 28, 2014

(51) Int. Cl. G06K 9/00; G06F 3/01

(52) U.S. Cl. CPC G06K 9/00845; G06K 9/0061; G06F 3/013

(57) ABSTRACT

A vehicle controller identifies a vehicle display within a driver field of view, identifies elements of viewable content including primary elements of viewable content deemed high priority for a current driving situation and secondary elements of viewable content that are driver-specified and deemed safe to display in accordance with a driver workload estimation, receives viewable content, and displays the identified elements of the viewable content on the vehicle display.

### TECHNICAL FIELD

The disclosure generally relates to use of workload estimation and driver gaze detection to show customizable viewable content to a vehicle driver.

### BACKGROUND

The number and size of informational displays within the vehicle cabin has dramatically increased over the past decade, along with the amount and diversity of available content. For example, content such as infotainment, phone integration, safety alerts, navigation displays, and driving efficiency may be displayed in various display screens throughout the vehicle cabin. The increased availability of information may be distracting and difficult for a driver to parse when attempting to locate the specific information that the driver would like to view.

### SUMMARY

In a first illustrative embodiment, a system includes a vehicle controller configured to identify a vehicle display within a driver field of view, identify elements of viewable content including primary elements of viewable content deemed high priority for a current driving situation and secondary elements of viewable content that are driver-specified and deemed safe to display in accordance with a driver workload estimation, and display the elements of the viewable content on the vehicle display.

In a second illustrative embodiment, a method includes identifying a vehicle display within a driver field of view, identifying elements of viewable content including primary elements of viewable content deemed high priority for a current driving situation and secondary elements of viewable content that are driver-specified and deemed safe to display in accordance with a driver workload estimation, and displaying the elements of the viewable content on the vehicle display.

In a third illustrative embodiment, a non-transitory computer-readable medium embodies instructions that, when executed by a vehicle processor, are configured to cause the processor to identify a vehicle display within a driver field of view, identify elements of viewable content including primary elements of viewable content deemed high priority for a current driving situation and secondary elements of viewable content that are driver-specified and deemed safe to display in accordance with a driver workload estimation, and display the elements of the viewable content on the vehicle display.

### BRIEF DESCRIPTION OF THE DRAWINGS

FIG. 1 illustrates an exemplary block topology of a vehicle infotainment system implementing a user-interactive vehicle based computing system;

FIG. 2 illustrates an exemplary driver gaze location set of viewable sub-regions available to a driver of a vehicle;

FIG. 3 illustrates an exemplary block diagram of a system for using workload estimation and driver gaze detection to show customizable information to the driver;

FIG. 4 illustrates an exemplary process for identifying information regarding vehicle displays 322 within the currently viewed sub-region of the driver gaze location set;

FIG. 5 illustrates an exemplary process for determining which elements of viewable content to display to the driver; and

FIG. 6 illustrates an exemplary process for using workload estimation and driver gaze detection to show customizable viewable content to a vehicle driver.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

In-vehicle content may include various types of information, such as infotainment, phone integration, safety alerts, navigation displays, and drive efficiency. These and other types of in-vehicle content may be displayed in the vehicle cabin for informational purposes to aid in the driving task, or simply for driver or passenger peace of mind.

Some in-vehicle content may be of a higher priority than other content. For instance, content such as vehicle speed, driving conditions, environmental conditions, or backseat monitoring may be relatively more important than other types of content, such as information regarding a currently playing song. Which specific types of content are deemed to be more important may vary from driving situation to driving situation, and also from driver to driver. In some cases, for content that the driver regards as important, the driver may desire to see that information regardless of which display he or she is currently viewing.

A system may be configured to maintain driver preferences regarding which information is deemed to be high priority to the driver, and default preferences regarding which information is deemed to be appropriate for the current driving situation (i.e., related to the primary driving task). The system may be further configured to perform gaze detection to determine which display devices of the vehicle are currently within a field of view of the driver. Based on the preferences and gaze detection, the system may be configured to display a customizable set of driver and default information on whichever vehicle display is visible and appropriate for the driver. In an example, the driver may select to that a look-ahead view be available to the driver on a vehicle display within the driver's field of view, even if the driver is looking at a side minor or rear mirror.

Depending on the relevance of the particular element of content to the current driving task, the system maybe further configured to filter the customizable set of displayed content according to estimated driver workload. Thus, less relevant information (i.e., related to secondary vehicle tasks) may only be displayed when driving risk is low enough that such content may be considered safe to provide. For example, if a driver with children prefers to be able to see a view of a child in the back seat, that driver may only be allowed to view that information when a driver workload estimate indicates providing such content would be safe. While traditionally it may have been inadvisable to display certain types of secondary information when the vehicle is in motion, it should be noted that the display of information related to secondary tasks in only somewhat heightened workloads would help the driver to keep his or her eyes on the primary driving task, rather than seeking out the secondary information elsewhere. For example, it may be preferable to display a video feed of the back seat in front of the driver, rather than having the driver take his or her eyes off the road when turning around.

In some cases, the system may include an optical head-mounted display (OHMD) may be configured to display driving assistance information to a driver. In such a system, the OHMD may provide content that would otherwise be displayed in one or more displays of the vehicle, allowing the total number of displays in the vehicle to be reduced. The OHMD could be cloud/vehicle connected to switch display contents depending on where the driver is looking when operating the vehicle. In an example, the OHMD may be configured to display a current travel direction look-ahead view when the gaze of the driver is determined to be focused away from the road, and display other supporting content when the gaze of the driver is determined to be focused within the look-ahead view on the road ahead.

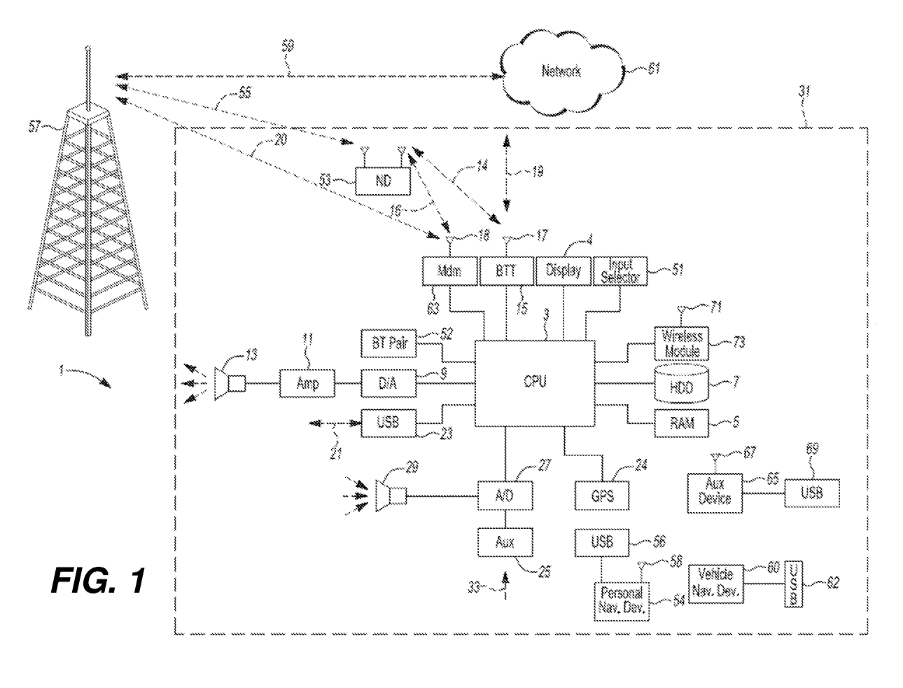

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, spoken dialog system with automatic speech recognition and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory. In general, persistent (non-transitory) memory can include all forms of memory that maintain data when a computer or other device is powered down. These include, but are not limited to, HDDs, CDs, DVDs, magnetic tapes, solid state drives, portable USB drives and any other suitable form of persistent memory.

The processor is also provided with a number of different inputs allowing the user to interface with the processor. In this illustrative embodiment, a microphone 29, an auxiliary input 25 (for input 33), a USB input 23, a GPS input 24, screen 4, which may be a touchscreen display, and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Domain Multiple Access (CDMA), Time Domain Multiple Access (TDMA), Space-Domain Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi (IEEE 803.11) 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing the process, since the wireless device would not “send and receive” information with itself. One of ordinary skill in the art will understand when it is inappropriate to apply a particular VACS to a given solution. In all solutions, it is contemplated that at least the vehicle computing system (VCS) located within the vehicle itself is capable of performing the exemplary processes.

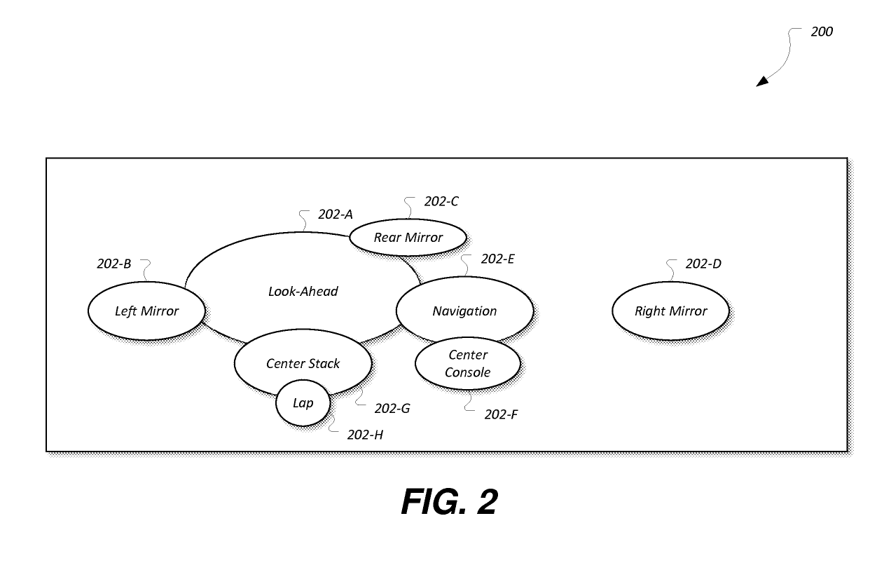

FIG. 2 illustrates an exemplary driver gaze location set 200 of viewable sub-regions 202-A through 202-H (collectively 202) available to a driver of a vehicle 31. The driver gaze location set 200 may generally include a set of possible locations within the vehicle 31 where a driver may be looking. Each of the possible locations may be referred to herein as a viewable sub-region 202. As illustrated, the sub-regions 202 of the driver gaze location set 200 are arranged spatially to illustrate the various possible targets for driver gaze within the vehicle 31 cabin.

Each sub-region 202 of the driver gaze location set 200 may be defined according to information regarding which portions of the vehicle 31 cabin are included within the sub-regions 202. These spatial locations may be represented in various ways, such as by a fixed or relative location within the vehicle 31 cabin. The size of each spatial location may be also identified in various ways, such as by a center point and a radius (for a spherical region), a center point and major and minor axes (for an ellipsoid region), rectangular coordinates (for a cuboid region), etc.

It should be noted that the particular sub-regions 202 of the location set 200 are merely exemplary, and variations on the location set 200 are likely and contemplated. For example, as vehicle 31 control layout may vary from vehicle 31 to vehicle 31, the spatial relationship between the viewable sub-regions 202 relative to one another may differ from vehicle 31 to vehicle 31. Moreover, as driver height and build vary from driver to driver, the exact boundaries of the sub-regions 202 may vary from driver to driver as well.

As illustrated, the exemplary driver gaze location set 200 may include a look-ahead sub-region 202-A in which the driver gaze is forward looking (e.g., out the front windshield at the road), a left mirror sub-region 202-B in which the driver gaze is directed at a driver-side minor, a right mirror sub-region 202-C in which the driver gaze is directed at a passenger-side minor, a rear-view mirror sub-region 202-D in which the driver gaze is directed at a rear-view mirror, a navigation sub-region 202-E in which the driver gaze is directed at a navigation screen or device located within the vehicle 31 cabin, a center-console sub-region 202-F in which the driver gaze is directed at vehicle 31 information and controls centrally-mounted in the vehicle 31 cabin, a center-stack sub-region 202-G in which the driver gaze is directed at vehicle 31 information and controls mounted about the steering wheel, and a lap sub-region 202-H in which the driver gaze is directed downwards towards the driver. While not illustrated, the driver gaze location set 200 may include other sub-regions 202 as well, such as a reversing sub-region 202-I in which driver gaze is directed rearwards out a rear windshield.

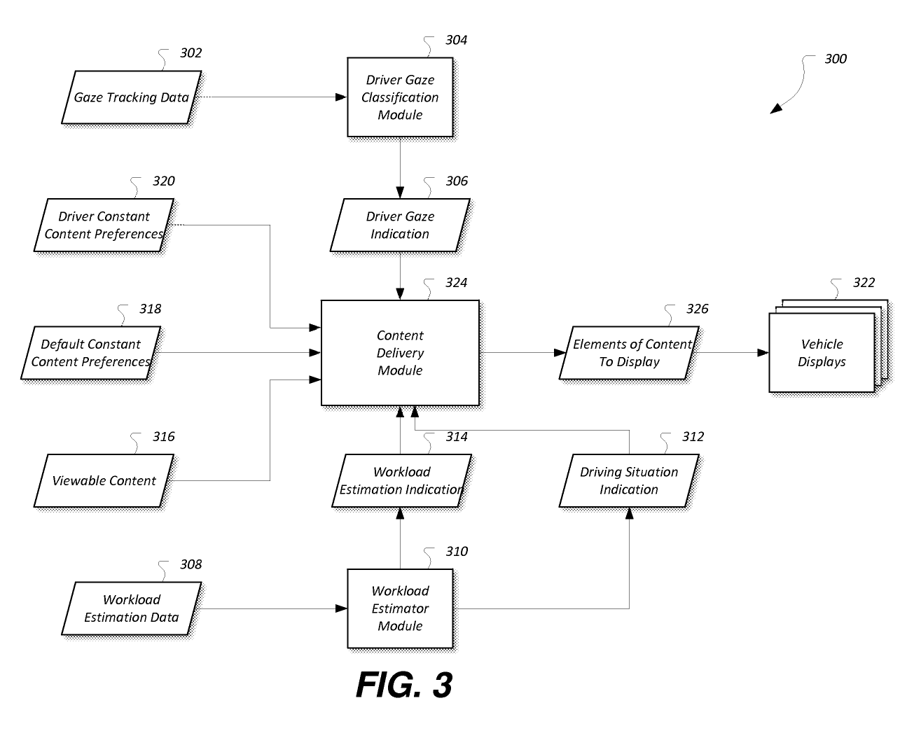

FIG. 3 illustrates an exemplary block diagram 300 of a system for using workload estimation and driver gaze detection to show customizable information to the driver. The modules of the exemplary system may be implemented by one or more processors or microprocessors of the vehicle 31 (such as the CPU 3 of the VCS 1) configured to execute firmware or software programs stored on one or more memory devices of the vehicle 31 (such as the storage 5 and 7). As illustrated, the system includes a driver gaze classification module 304 configured to receive gaze tracking data 302 and determine a driver gaze indication 306. The system further includes a workload estimator module 310 configured to receive workload estimation data 308 and determine a driving situation indication 312 and a workload estimation indication 314. The system also includes a content delivery module 324 configured to receive the driver gaze indication 306, the driving situation indication 312, the workload estimation indication 314, as well as viewable content 316, default constant content preferences 318, and driver constant content preferences 320, and determine a set of elements of viewable content 326 to be displayed via which vehicle displays 322. It should be noted that the modularization illustrated in the diagram 300 is exemplary, and other arrangements or combinations of elements including more, fewer, or differently separated modules may be used.

The gaze tracking data 302 may include information useful for identifying in what direction a driver is directing his or her gaze. In an example, the gaze tracking data 302 may include image data including a frontal image of the face of the driver. The image data may be captured, for example, by one or more image capture devices located within the vehicle cabin and aimed at the driver, such as image capture devices located in the vehicle dash, steering wheel, or headliner.

The driver gaze classification module 304 may be configured to receive the gaze tracking data 302 and determine a driver gaze indication 306. For example, the driver gaze classification module 304 may use image recognition techniques on the gaze tracking data 302 to determine a location of the driver's pupil or iris in relation to the driver's eye, as well as an identification of the head pose of the driver. The driver gaze classification module 304 may further utilize a head model, with the determined eye locations oriented according to the identified head pose, to geometrically estimate the location within the vehicle 31 where the driver is looking.

Accordingly, based on the estimated eye location and head position, the driver gaze classification module 304 may determine a driver gaze indication 306 indicative of which vehicle location is currently receiving the gaze of the driver. In an example, the driver gaze indication 306 may be indicative of which of the sub-regions 202 of the driver gaze location set 200 is currently receiving the gaze of the driver.

The workload estimation data 308 may include various inputs that may be monitored to aid in determining a driver workload. Exemplary workload estimation data 308 may include, for example, speed, yaw, pitch, roll, lateral acceleration, temperature, and rain sensor inputs, as some possibilities. In some cases, the workload estimation data 308 may include elements of data made available via a vehicle bus (e.g., via the controller area network (CAN)). In other cases, the workload estimation data 308 may include elements of data that may be otherwise received from vehicle 31 sensors and systems (e.g., yaw information received from a stability system, rain sense information received from a weather detection system, etc.).

The workload estimator module 310 may be configured to receive the workload estimation data 308 (e.g., via the CAN bus, from the vehicle systems or sensors, etc.) and determine a driving situation indication 312. The workload estimator module 310 may, for example, identify from the input a driving situation indication 312 such as high traffic density, lane changing, or certain road geometries with relatively higher driving demand such as an intersection or a merge situation.

For instance, the workload estimator module 310 may be configured to utilize a set of rules to facilitate the determination of the driving situation indication 312. Based on the received inputs, the workload estimator module 310 may be configured to match the received workload estimation data 308 against one or more conditions specified by the rules, where each rule may be defined to indicate a particular driving situation indication 312 encountered by the vehicle 31 when the conditions of the rule are satisfied.

As one example, a rule for identifying a high acceleration demand driving situation may include a condition wherein accelerator pedal position or longitudinal acceleration workload estimation data 308 exceed a predetermined threshold. As another example, a rule for identifying a high braking demand driving situation may include a condition wherein brake pedal position or longitudinal deceleration exceeds a predetermined threshold. As yet a further example, a rule for identifying an intersection driving situation may include a condition that a yaw angle is approximately 90°, where the yaw angle is determined according to integration of the yaw rate along the vehicle trajectory. As an even further example, a rule for identifying a merge driving situation may include a condition that lateral vehicle motion exceeds a threshold amount of lateral motion, and further that the current vehicle speed has reduced in a predefined time period by at least a threshold amount of speed. Or, a rule for identifying a reversing driving situation may include a condition that the selected vehicle gear is reverse.

Based on the determined driving situation indication 312, the workload estimator module 310 may further identify a workload estimation indication 314 associated with the driving situation indication 312. For example, each driving situation indication 312 may be associated with a corresponding workload estimation indication 314 (e.g., merge situations associated with a mid-level workload estimation indication 314, high traffic density associated with a high-level workload estimation indication 314). As another example, the workload estimator module 310 may associate certain conditions such as extreme weather with heightened driving demand, such that, as one possibility, the workload estimator module 310 may associate certain weather conditions combined with a mid-level demand area (e.g., a merge situation) with a heightened workload estimation, such as a high-level workload estimation indication 314. In some cases, the workload estimator module 310 may specify the workload estimation indication 314 as a value along a scale (e.g., from 1 to 5, from 0.01 to 1.00, etc.) indicating a relative level of current driver workload.

The viewable content 316 may include various types of information that may be provided to a driver of a vehicle 31. The viewable content 316 may be available to the system in various ways, such as via elements of data made available via a vehicle bus (e.g., the CAN), and/or otherwise received from vehicle 31 sensors and systems (e.g., from a camera subsystem, driver safety system, etc.). The viewable content 316 may include primary information that may be considered critical for the primary driving task or information that otherwise impacts the ability of the driver to operate the vehicle 31 safely. Viewable content 316 of this type may include, as some examples, a road-ahead camera image, blind spot information (BLIS) indications, collision warning information, and navigational information.

The viewable content 316 may also include secondary information that may not be driving-task-centric or safety-related, but that provides other benefits to the driver or other vehicle occupants, such as convenience or peace of mind. Viewable content 316 of this type may include, for example current speed limit vs. posted speed limit information, rear camera view information, drive efficiency information such as fuel economy tips or coaching information, a rear seat informational camera view, infotainment information about media content being played back, or phone information such as address book or call status. In some examples, each element of secondary information may further be associated with information indicative of under which workload estimation indications 314 the element of secondary information may be displayed to the driver. For instance, current speed limit may be indicated as being displayable in all by the highest driver workloads, while a rear seat informational camera may be indicated as being displayable only during low-level to mid-level driver workloads.

The default constant content preferences 318 may include elements of primary viewable content 316 determined by the system to be critical for the primary driving task or that are otherwise safety-related. As primary driving task may be identified according to the driving situation indication 312, the default constant content preferences 318 may include a listing of associated elements of viewable content 316 that should be provided to the user for the corresponding driving situation indication 312. As some example, blind spot monitoring information may be associated as critical to merge driving situations, and rear view camera view information may be associated as critical to reversing driving situations. It should be noted that primary viewable content 316 indicated by the default constant content preferences 318 as being preferred for display may generally be provided to the driver regardless of workload estimation indication 314.

The driver constant content preferences 320 may include elements of secondary viewable content 316 selected by the driver. It should be noted that second viewable content 316 indicated by the driver constant content preferences 320 as being preferred for display may generally be provided to the driver if the workload estimation indication 314 permits such content to be displayed. However, it should also be noted that the display of information related to secondary tasks would help the driver to keep his or her eyes on the primary driving task, rather than seeking out the secondary information elsewhere.

The driver constant content preferences 320 may be received by the system according to a user interface of the vehicle 31. The user interface may be provided to the driver in various ways, such as via the display 4 of the VCS 1, by way of voice commands received via the microphone 29 and recognized by system for use by the VCS 1, etc. In an example, the user interface may include a listing of possible elements of viewable content 316, as well as one or more controls or commands configured to allow the user to select the elements that the user would like to be displayed. As another example, the user interface may include one or more controls configured to allow the user to cycle among a set of available elements of viewable content 316 to choose a selected element to be displayed.

The vehicle displays 322 may include one or more in-vehicle displays configured to provide viewable content 316 to the driver or other vehicle 31 occupants. Exemplary vehicle displays 322 may be located within various viewable sub-regions 202-of the vehicle 31. For instance, the vehicle 31 may include one or more display screens of a head unit of the VCS 1 located within the navigation sub-region 202-E and/or center-console sub-region 202-F, displays integrated into side or rear view mirrors of the vehicle 31 within sub-regions 202-B through 202-D, and informational displays included in the center stack of the vehicle 31. As another example, the vehicle 31 may include an image projectable windshield or a heads-up display within sub-region 202-A configured to display content to a driver looking through the front windshield.

In some cases, instead of or in addition to one or more of the vehicle-integrated displays, the vehicle displays 322 may also include an optical head-mounted display (OHMD) or other display wearable by the driver that moves along with the driver's head. As the wearable display moves with the driver, the wearable display may be considered viewable by the driver regardless of the driver's gaze.

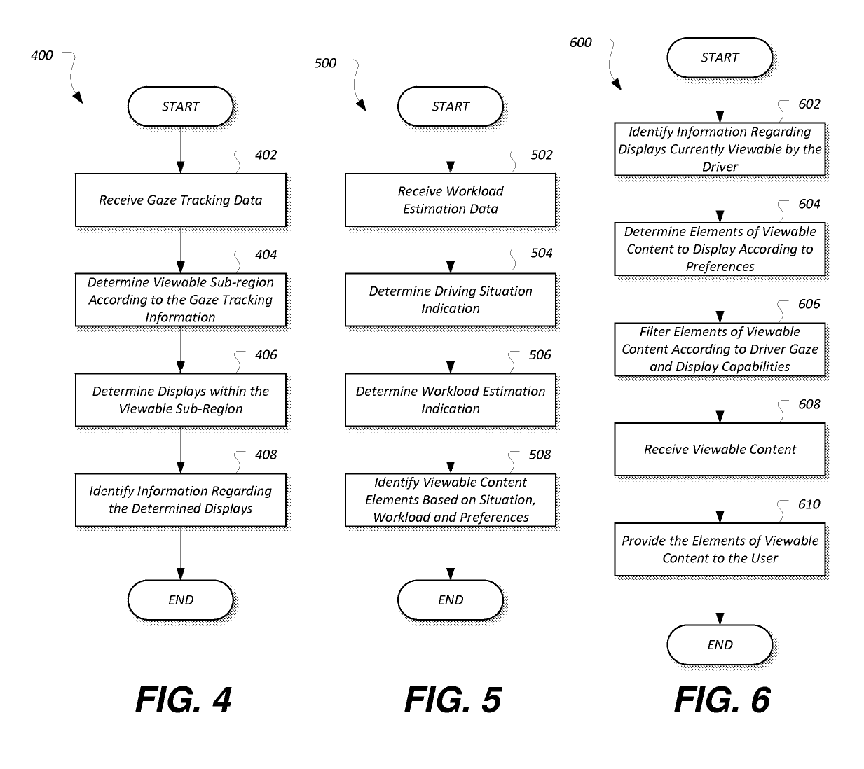

The content delivery module 324 may be configured to receive the viewable content 316, and determine a set of elements of viewable content 326 for display according to information such as the driver gaze indication 306, the workload estimation indication 314, the default constant content preferences 318, the driver constant content preferences 320, and the physical limitations of the vehicle display modules 322. To facilitate the determination, the content delivery module 324 may be configured to maintain various types of information useful in formatting viewable content 216 for display. As one example, the content delivery module 324 may be configured to maintain information regarding the amount of display space or area required to display various elements of viewable content 316. As another example, the content delivery module 324 may be configured to maintain information regarding the capabilities of the available vehicle displays 322 (e.g., screen resolution and size, color depth, dot pitch, refresh rate, etc.). The content delivery module 324 may, for example, query the vehicle displays 322 for their capability information (e.g., via a standard such as plug-n-play, by identification of make and model of the display 322, etc.) or may be programmed with the capabilities of the vehicle display modules 322 as built (e.g., using factory vehicle 31 configuration information). Further aspects of the operation of the content delivery module 324 are discussed below with respect to FIGS. 4-6.

FIG. 4 illustrates an exemplary process 400 for identifying information regarding vehicle displays 322 within the currently viewed sub-region 202 of the driver gaze location set 200. The process 400 may be performed, for example, by the VCS 1 of the vehicle 31, by other controllers of the vehicle 31, or distributed amongst multiple controllers of the vehicle 31.

At block 402, the vehicle 31 receives gaze tracking data 302. For example, the driver gaze classification module 304 may receive image data, including a frontal image of the face of the driver, captured by one or more image capture devices located within the vehicle cabin and aimed at the driver. As some possibilities, the one or more image capture devices may be located within the vehicle cabin at locations such as on the vehicle dash, on the steering wheel, or in the vehicle 31 cabin headliner.

At block 404, the vehicle 31 determines the currently viewed sub-region 202 of the vehicle 31 according to the gaze tracking data 302. For example, based on the gaze tracking data 302, the driver gaze classification module 304 may determine the driver's eye position and the driver's head position. The driver gaze classification module 304 may further utilize a head model to estimate the location within the vehicle 31 where the driver is looking. Based on the estimated location and spatial information regarding which spatial locations are included within the sub-regions 202 for the vehicle 31, the driver gaze classification module 304 may identify a driver gaze indication 306 indicative of the sub-region 202 of the driver gaze location set 200 driver is currently receiving the driver's gaze (or the sub-region 202 closest to the driver's gaze).

At block 406, the vehicle 31 determines the vehicle displays 322 within the viewable sub-region 202. For example, based on the driver gaze indication 306 indicative of the sub-region 202 of the driver gaze, and information indicative of which vehicle displays 322 are located within which sub-regions 202, the content delivery module 324 may identify which vehicle displays 322 are within the gaze of the driver. As another example, if the driver is wearing an OHMD vehicle display 322, then that vehicle display 322 may further be considered to be within the gaze of the wearer.

At block 408, the vehicle 31 identifies information regarding the determined vehicle displays 322. For example, the content delivery module 324 may query the determined vehicle displays 322 for their capability information (e.g., via a standard such as plug-n-play) or may be programmed with the capabilities of the vehicle display modules 322 as built. Based on the information, the content delivery module 324 may identify the capabilities of the determined vehicle displays 322 (e.g., screen resolution and size, color depth, dot pitch, refresh rate, etc.). This information may be useful for the content delivery module 324 in determining what and how much viewable content 316 may be displayed by the determined vehicle displays 322. After block 408 the process 400 ends.

FIG. 5 illustrates an exemplary process 500 for determining which elements of viewable content 316 to display to the driver. As with the process 400, the process 500 may be performed, for example, by the VCS 1 of the vehicle 31. In other examples, the process 500 may be implemented in other controllers, or distributed amongst multiple controllers.

At block 502, the vehicle 31 receives workload estimation data 308. For example, the workload estimator module 310 may receive workload estimation data 308 made available via a vehicle bus (e.g., via the controller area network (CAN)). In other cases, the workload estimator module 310 may receive workload estimation data 308 from vehicle 31 sensors and systems (e.g., yaw information received from a stability system, rain sense information received from a weather detection system, etc.). Exemplary workload estimation data 308 may include, for example, speed, yaw, pitch, roll, lateral acceleration, temperature, and rain sensor inputs, as some possibilities.

At block 504, the vehicle 31 determines a driving situation indication 312. For example, the workload estimator module 310 may utilize system rules and condition to determine, from the workload estimation data 308, a driving situation indication 312. The driving situation indication 312 may be indicative of a current situation being experienced by the vehicle 31, such as high traffic density, lane changing, or certain road geometries with relatively higher driving demand such as an intersection or a merge.

At block 506, the vehicle 31 determines a workload estimation indication 314. For example, the workload estimator module 310 may look up an associated workload estimation indication 314 corresponding to the determined driving situation indication 312. For instance, the workload estimator module 310 may determine a mid-level workload estimation indication 314 upon determination of a merge situation driving situation indication 312, or a high-level workload estimation indication 314 upon determination of a high traffic density driving situation indication 312. Additionally, the workload estimator module 310 may adjust the corresponding workload estimation indication 314 based on other received workload estimation data 308. For instance, the workload estimator module 310 may associate certain weather conditions combined with a mid-level demand area (e.g., a merge situation) with heightened workload estimation (e.g., a high-level demand).

At block 508, the vehicle 31 identifies viewable content 316 elements to be displayed to the driver. For example, based on the determined driving situation indication 312, the content delivery module 324 may utilize the default constant content preferences 318 to identify elements of viewable content 316 associated with the driving situation indication 312 as being relatively critical for the primary driving task. As another example, based on the driver constant content preferences 320, the content delivery module 324 may identify elements of secondary viewable content 316 indicated by the driver (e.g., previously input into a user interface of the VCS 1) as being preferred for display by the driver. After block 508, the process 500 ends.

FIG. 6 illustrates an exemplary process 600 for using workload estimation and driver gaze detection to show customizable viewable content 316 to a vehicle driver. As with the processes 400 and 500, the process 600 may be performed, for example, by the VCS 1 of the vehicle 31. In other examples, the process 600 may be implemented in other controllers, or distributed amongst multiple controllers.

At block 602, the vehicle 31 identifies information regarding vehicle displays 322 that are currently viewable by the vehicle 31 driver. For example, the vehicle 31 may utilize a process such as the process 400 to determine which vehicle displays 322 are within the driver's gaze, and what capabilities for showing viewable content 316 the determined vehicle displays 322.

At block 604, the vehicle 31 determines elements of viewable content 316 for display. For example, the vehicle 31 may utilize a process such as the process 500 to determine which elements of viewable content 316 to display according to the current driver workload, situation, and preferences.

At block 606, the vehicle 31 filters the identified viewable content 316 elements. This filtering may be performed by the content delivery module 324 according to information such as the driver gaze indication 306 and information regarding vehicle displays 322 within the currently viewed sub-region 202 of the driver gaze location set 200.

As an example, the content delivery module 324 may filter elements of the identified viewable content 316 to remove elements that are unnecessary as being otherwise visible within the driver field of view. For instance, if the current driving task is reversing, the driver is wearing an OHMD vehicle display 322, and the driver gaze indication 306 indicates that the driver is facing rearward, then a reverse camera view may be filtered out of the identified viewable content 316 elements to be provided to the OHMD.

As another example, the content delivery module 324 may filter the identified viewable content 316 elements to include those elements that are of higher importance, e.g., the primary task information having priority in the vehicle displays 322 over secondary information. For instance, the content delivery module 324 may determine based on an amount of display space required for each element of viewable content and further according to the availability of display area indicated by the information regarding vehicle displays 322, which elements of viewable content 316 may not be able to fit within the vehicle displays 322. If so, the content delivery module 324 may remove elements of the identified viewable content 316 elements (beginning with the secondary information), until the elements may fit within the available vehicle displays 322. In some cases, the elements of viewable content 316 may be ranked in an order of importance, and those elements that are relatively lower ranked may be removed from display first if space is limited.

At block 608, the vehicle 31 receives viewable content 316. For example, the content delivery module 324 may receive elements of viewable content 316 via elements of data made available via a vehicle bus (e.g., the CAN), and/or otherwise received from vehicle 31 sensors and systems (e.g., from a camera subsystem or driver safety system).

At block 610, the vehicle 31 provides the identified elements of viewable content 326 to the identified vehicle displays 322. For example, if a driver is traveling straight ahead but viewing a side mirror having an auxiliary display, the content delivery module 324 may provide a forward road ahead view on the mirror display. As another example, if a driver has children and requests to display a back seat view, then when the river is viewing the road ahead, the back seat view may be provided on a heads-up windshield display to the driver when workload permits. Thus, as in these and other examples, the content delivery module 324 may format the received viewable content 316 to display the identified elements of viewable control 326 in the vehicle displays 322 that are currently viewable by the vehicle 31 driver. After block 610, the process 600 ends.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a vehicle controller configured to
identify a vehicle display within a driver field of view,
identify elements of viewable content including primary elements of viewable content deemed high priority for a current driving situation and secondary elements of viewable content that are driver-specified and deemed safe to display in accordance with a driver workload estimation, and
display the identified elements of the viewable content on the vehicle display.

2. The system of claim 1, wherein the vehicle controller is further configured to determine the vehicle display as being within the field of view of the driver according to (i) a driver gaze indication indicative of a vehicle location at which a gaze of the driver is directed and (ii) information regarding locations of displays within the vehicle.

3. The system of claim 2, wherein the vehicle controller is further configured to filter the primary elements of viewable content to remove elements that are unnecessary as being otherwise visible within the driver field of view.

4. The system of claim 2, wherein the vehicle controller is further configured to filter the secondary elements of viewable content in accordance with display attributes of the vehicle display within the driver field of view.

5. The system of claim 2, wherein the vehicle controller is further configured to:
estimate the vehicle location where the driver is looking according to a location of an element of an eye of the driver and a head pose of the driver; and
determine the driver gaze indication as corresponding to the vehicle location.

6. The system of claim 1, wherein the vehicle controller is further configured to:
receive workload estimation data;
determine the driving situation based on the workload estimation data; and
determine the driver workload estimation according to the driving situation.

7. The system of claim 1, wherein each of the secondary elements of viewable content is associated with allowable workload information indicative of under which workload estimation indications the secondary elements of viewable content is displayable, and wherein the vehicle controller is further configured to determine which of the secondary elements are deemed safe to display based on the driver workload estimation and the allowable workload information.

8. A method comprising:
identifying a vehicle display within a driver field of view,
identifying elements of viewable content including primary elements of viewable content deemed high priority for a current driving situation and secondary elements of viewable content that are driver-specified and deemed safe to display in accordance with a driver workload estimation, and
displaying the identified elements of the viewable content on the vehicle display.

9. The method of claim 8, further comprising determining the vehicle display as being within the field of view of the driver according to (i) a driver gaze indication indicative of a vehicle location at which a gaze of the driver is directed and (ii) information regarding locations of displays within the vehicle.

10. The method of claim 9, further comprising filtering the primary elements of viewable content to remove elements that are unnecessary as being otherwise visible within the driver field of view.

11. The method of claim 9, further comprising filtering the secondary elements of viewable content in accordance with display attributes of the vehicle display within the driver field of view.

12. The method of claim 9, further comprising:
estimating the vehicle location where the driver is looking according to a location of an element of an eye of the driver and a head pose of the driver; and
determining the driver gaze indication as corresponding to the vehicle location.

13. The method of claim 8, further comprising:
receiving workload estimation data;
determining the driving situation based on the workload estimation data; and
determining the driver workload estimation according to the driving situation.

14. The method of claim 8, wherein each of the secondary elements of viewable content is associated with allowable workload information indicative of under which workload estimation indications the secondary elements of viewable content is displayable, and further comprising determining which of the secondary elements are deemed safe to display based on the driver workload estimation and the allowable workload information.

15. A non-transitory computer-readable medium embodying instructions that, when executed by a vehicle processor, are configured to cause the processor to:
identify a vehicle display within a driver field of view,
identify elements of viewable content including primary elements of viewable content deemed high priority for a current driving situation and secondary elements of viewable content that are driver-specified and deemed safe to display in accordance with a driver workload estimation, and
display the identified elements of the viewable content on the vehicle display.

16. The medium of claim 15, further embodying instructions configured to cause the processor to determine the vehicle display as being within the field of view of the driver according to (i) a driver gaze indication indicative of a vehicle location at which a gaze of the driver is directed and (ii) information regarding locations of displays within the vehicle.

17. The medium of claim 16, further embodying instructions configured to cause the processor to:
filter the primary elements of viewable content to remove elements that are unnecessary as being otherwise visible within the driver field of view; and
filter the secondary elements of viewable content in accordance with display attributes of the vehicle display within the driver field of view.

18. The medium of claim 16, further embodying instructions configured to cause the processor to:
estimate the vehicle location where the driver is looking according to a location of an element of an eye of the driver and a head pose of the driver; and
determine the driver gaze indication as corresponding to the vehicle location.

19. The medium of claim 15, further embodying instructions configured to cause the processor to:
receive workload estimation data;
determine the driving situation based on the workload estimation data; and
determine the driver workload estimation according to the driving situation.

20. The medium of claim 15, wherein each of the secondary elements of viewable content is associated with allowable workload information indicative of under which workload estimation indications the secondary elements of viewable content is displayable, and wherein the medium further embodies instructions configured to cause the processor to determine which of the secondary elements are deemed safe to display based on the driver workload estimation and the allowable workload information.
